(19) United States
(12) Patent Application Publication
(10) Pub. No.: US 2023/0276082 A1
(43) Pub. Date: Aug. 31, 2023

(54) PRODUCING VIDEO FOR CONTENT INSERTION

(71) Applicant: Mo-Sys Engineering Limited, London (GB)

(72) Inventors: Michael Paul Alexander Geissler, London (GB); James Michael Uren, London (GB)

(73) Assignee: Mo-Sys Engineering Limited, London (GB)

(21) Appl. No.: 17/995,255

(22) PCT Filed: Apr. 1, 2021
(86) PCT No.: PCT/GB2021/050826

§ 371 Date: Sep. 30, 2022

(30) Foreign Application Priority Data
Apr. 3, 2020 (GB) 2004965.6

(51) Int. Cl. H04N 21/234; H04N 21/235

(52) U.S. Cl. CPC H04N 21/23424; H04N 21/2353

(57) ABSTRACT

A system for capturing a video stream, the system comprising: a camera; and an encoding device configured to store video captured by the camera together with metadata indicating a location in the video at which a predesignated substitution object appears.

This invention relates to producing and adapting video.

It is possible to adapt a video stream to change some of the content in it. For example, it is known to identify an object such as a billboard in a video stream, and replace what appears to be displayed on that object. The object can be identified manually or automatically. To make the object reliably identifiable it is known to ensure it is in a predetermined colour, most conventionally green. One use of this technology is to allow a video stream to contain advertisements that are targeted to a specific viewer or are up-to-date for the time when the video stream is played out. Another use is to modify a story being portrayed by the video: for example words in a book displayed in the video could be adapted to be in a language suitable for a specific viewer or set of viewers or they could be adapted to give a different message that changes the meaning of the video.

There are several difficulties with implementing this technology. Taking the example of a billboard, a suitable billboard for adaptation must first be identified in the original video stream. Then, in order for any new information that is to appear to be displayed on the billboard to look realistic, the position, size and distortion of that information must over time match changes in the position and angle of the camera that originally captured the video. Typically these adjustments are done manually, which is time-consuming. In addition, it may be difficult for the person who originally makes the video to include suitable opportunities to adapt the video content.

There is a need for an improved way of producing and adapting video.

According to one aspect there is provided a system for capturing a video stream, the system comprising: a camera; and an encoding device configured to store video captured by the camera together with metadata indicating a location in the video at which a predesignated substitution object appears.

The metadata may indicate times during the video at which the substitution object appears.

The metadata may indicate regions of the video occupied by the substitution object over time.

The metadata may indicate a size and shape of the substitution object.

The metadata may indicate one or more characteristics of a lens of the camera at one or more times when the substitution object appears in the video.

The metadata may indicate one or more colour characteristics of the video at one or more times when the substitution object appears in the video.

The system may comprise an input device whereby a user can input at least some of the metadata to the system.

According to a second aspect there is provided a system for processing video to replace substitutable content in the video with alternative content, the system comprising a processor configured to: process metadata associated with the video to identify a region in the video in which the substitutable content appears; select, in dependence on the metadata, an item of alternative content from a datastore storing alternative content; and process the video to replace regions of the video defined by the metadata with substituted content formed in dependence on the alternative content.

The metadata may indicate a pose of a camera that captured the video at a time when the substitutable content appears in the video. The processor may be configured to spatially distort the alternative content in dependence on the indicated pose to form the substituted content.

The metadata may indicate one or more characteristics of a lens of the camera at a time when the substitutable content object appears in the video. The processor may be configured to spatially distort the alternative content in dependence on the indicated lens characteristics to form the substituted content.

The metadata may indicate one or more colour characteristics of the video at a time when the substitutable content appears in the video. The processor may be configured to chromatically distort the alternative content in dependence on the indicated lens characteristics to form the substituted content.

According to a third aspect there is provided a method for playing out a video stream, the method comprising: forming a first video stream for playout, the first video stream depicting at least one space for substitution by an overlay; forming a second video stream for playout, the second video stream having an omission corresponding to the first video stream; playing out the second video stream; stopping playout of the second video stream at the omission; subsequently, playing out the first video stream with the space substituted by an overlay; subsequently playing out a further portion of the second video stream.

The method may comprise storing video captured by a camera together with metadata indicating a location in the video at which a predesignated substitution object appears.

According to a fourth aspect there is provided a method for processing a video stream to replace substitutable content in the video stream with alternative content, the method comprising: processing metadata associated with the video stream to identify a region in the video stream in which the substitutable content appears; selecting, in dependence on the metadata, an item of alternative content from a datastore storing alternative content; and processing the video stream to replace regions of the video stream defined by the metadata with substituted content formed in dependence on the alternative content.

The method may comprise processing the video stream to determine whether the video stream contains data indicating that it complies with one or more standard formats, and replacing regions of the video stream as set out above only if the video stream contains such data.

Any processor may be constituted by a single CPU or may be distributed between multiple CPUs, which may be located together or at different locations.

Apparatus may be provided for implementing the methods set out above. The methods may be implemented by one or more suitably programmed computers.

According to a fifth aspect there is provided a method for processing a video stream to replace substitutable content in the video stream with alternative content, the method comprising: processing the video stream using a computer programmed to implement an image recognition algorithm to identify in the video stream depictions of an environment having a propensity to contain one or more predetermined objects; retrieving from a data store a model of one of the predetermined objects; and processing the video stream to replace regions of the video stream depicting the identified environment with substituted content formed in dependence on the retrieved model.

The present invention will now be described by way of example with reference to the accompanying drawings.

In the drawings:

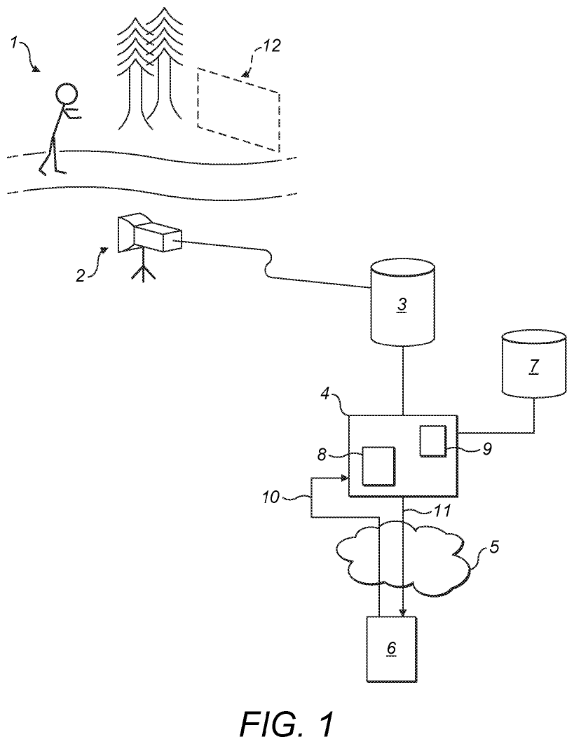

FIG. 1 shows the architecture of a video capture and post-production system.

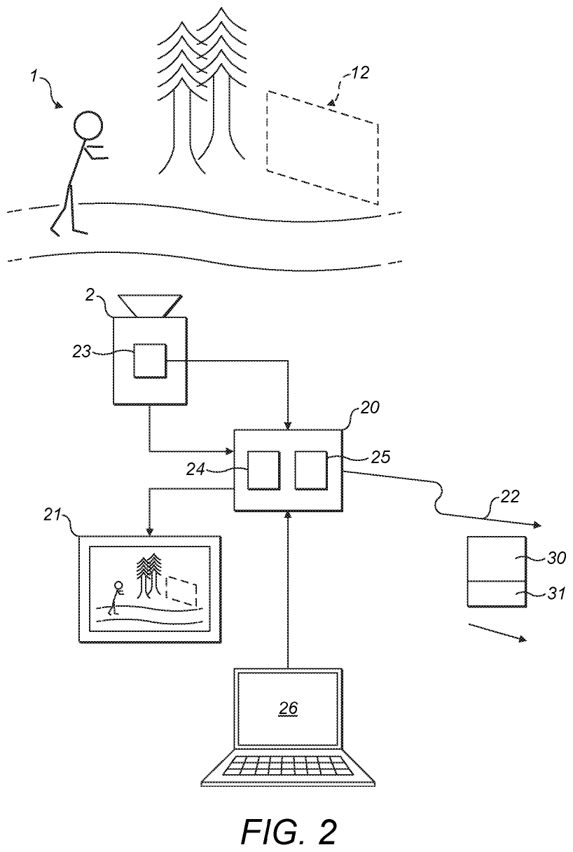

FIG. 2 shows in more detail the video capture system of FIG. 1.

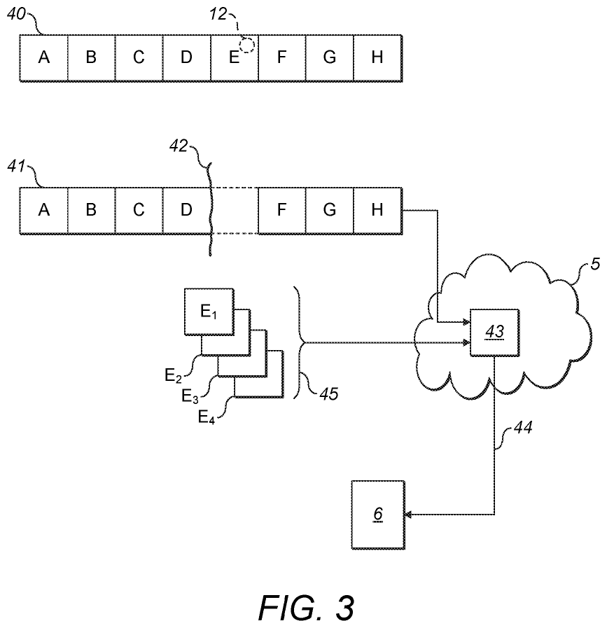

FIG. 3 shows a workflow in which different streams of video are combined.

FIG. 1 shows a system for capturing video and then processing the captured video to adapt it visually.

In the system of FIG. 1, a scene 1 is viewed by a camera 2. The camera captures and stores a video stream depicting the scene. The captured video is stored in a data store 3. The data store 3 may be remote from the camera. A video playout system 4 has access to the data store. An end-user can request video from the playout system. The playout system can then play selected video to a device 6 of the end-user by transmitting the video over a communication path 11. The end-user device may, for example, be a phone, tablet or computer. The communication path may extend over a publicly accessible network such as the internet.

The playout system may play out the original video as captured by the camera, or it may play out an adapted version of the original video. An adapted version of the video may be adapted in numerous ways. One example will be described for illustration. The end-user device 6 transmits context information to the playout system over a channel 8. The context information represents the context of the user device 6: for example its location or information about the past behaviour of a user device, for example in the form of cookies. The playout system has a processor 8 and a memory 9 which stores in non-transient form code for execution by the processor 8 to cause it to make the playout system function as described herein. The playout system 8 has access to an advertisement database 7 which stores a series of advertisements. In dependence on the context information received from the user and/or on other information which can be stored in database 7, such as indications of which of the advertisements are suitable for inclusion in a specific video stream and which advertisements are to be prioritised for inclusion (which may be dependent on the level of bids from potential advertisers) the playout system selects an advertisement for inclusion in the video stream as played out to the user of device 6. The playout system retrieves that advertisement from database 7. A region 12 of the scene in the video has been reserved for placement of advertisements. The playout system forms an adapted video which is based on the originally captured video but in which the selected advertisement has been placed in the part of the video corresponding to region 12. The way in which this is done will be described in more detail below. Then the adapted video is played out to the device 6 for presentation there to the user. In this way, the user receives a customised advertisement. The advertisement is integrated into the video so that it appears to have been present when the video was originally shot. The same approach may be used to adapt visual elements in the video for different languages (e.g. by changing text to a language suitable for the user as indicated by the context data) or to provide different storylines.

Other information may be used to select an advertisement for playout in a specific slot. For example, the advertisement may be selected such that its principal or highlight colour matches the colour of a prominent object depicted in the video alongside the overlain advertisement. Or the advertisement may be selected such that the character of its brand matches a characteristic of such a prominent object.

An advertisement may communicate branding or marketing information or may communicate other information such as educational information, public service information or equipment test information. An advertisement may take the form of a still image or a video segment. An advertisement could be amplified through supporting exposures on the same screen: e.g. corner bugs, scrollers or squeezebacks or watermarks such as audio codes.

The video may be stored in a compressed and/or video encoded format. To overlay the advertisement or other replacement content on the video, the video may be decompressed and/or decoded to yield a series of video frames or part-frames. The frames or part-frames that are to display the replacement content are adapted by overlaying that content on the respective frames or part-frames. Then the video may be re-compressed and/or re-encoded and stored and/or transmitted to the end-user device.

When the replacement content is overlain on the video, it is preferable that this is done in a way that causes the replacement content to appear as if it was originally present when the video was shot. To achieve this, the replacement content can be distorted (e.g. by one or more of hue adjustment, brightness adjustment, contrast adjustment, scaling, trapezoidal transformation, rotation, barrel transformation and pincushion transformation) to match any changes in the video resulting from motion of the camera when the video was captured, lens distortion etc. Mechanisms to achieve this will be discussed further below.

FIG. 2 shows in more detail the video capture system of FIG. 1.

The camera 2 provides a feed of captured video to preview unit 20. A display 21 is provided to allow the captured video to be viewed. The display 21 could be integrated with the camera, to allow an operator of the camera to see the images on the display whilst capturing the video. The camera is equipped with a monitoring unit 23. The monitoring unit determines one or more of (i) the position of the camera relative to the scene 1, (ii) the direction of the field of view of the camera relative to the scene 1, (iii) the optical state of the camera. The optical state of the camera could include one or more of the focal length of the lens being used by the camera, the aperture of that lens, the make of that lens, the model of that lens and colour parameters being used by the camera (e.g. white balance or colour space). The monitoring unit provides that information to the preview unit 20.

The preview unit comprises a processor 24 and a memory 25. The memory stores in a non-transient way code executable by the processor 24 to cause the preview unit to execute the functions described herein. The preview unit receives information from an input device, such as console 26, indicating one or more spaces in the scene that are—like space 12—to be allocated for the addition of information during post-processing by adapting the captured video. The preview unit may also receive from the input device an indication of what information is to be added at a space: e.g. an image of a billboard, an image of a bus shelter or an image of a delivery van. The images may be captured by cameras or may be computer-generated. The preview unit receives the captured video from the camera 23 and forms an preview video stream in which the captured video has been adapted to show the designated type of object, or a neutral pattern such as cross-hatching, at the designated space. The inserted object or pattern is referred to as an overlay. That preview video stream is provided to display 21. In that way, an operator at the video capture facility can gain an impression of the scene as it will appear once the captured video has been adapted at the playout system 4. This can help the operator to compose the captured video stream.

When the preview unit adapts the captured video in this way it may do so in dependence on the information received from the monitoring unit. The preview unit determines the scale, position, distortion, colour and angle of the inserted content in dependence on the information received from the monitoring unit. For example:
As the camera 2 pans or tilts the location in the video stream at which space 12 is portrayed will change. The preview unit can determine using the information from the monitoring unit the location in the video stream at which space 12 is portrayed, and can insert the overlay so it appears to be in the scene 1 even as the camera moves.
As the camera 2 zooms, the size of the overlay can be adapted in an analogous way.
As the space 12 is depicted at different locations in the video stream, the influence of distortion from the camera lens on objects adjoining the space will change. That distortion can be predicted by the preview unit based on information about lens behaviour stored in memory 25, and the preview unit can then distort the overlay so it looks to be coordinated with the captured video stream.
The colouring (including factors such as brightness, contrast and white balance) of the overlay can be selected to match the colour balance in the captured video stream In summary, the preview unit automatically determines one or more of the size, position, shape and colouring of the overlay to match the position, attitude and configuration of the camera. In that way the overlay can appear as if it has been captured as part of the captured video stream. This can avoid the need for post production compositing, other possibly than colour correction and audio integration.

The camera 2 and/or the preview unit and/or another unit associated with the capture system store with the video information about the timing(s) at which a space 12 appears in the video stream, the position(s) at which it appears and any desired additional information such as, for each relevant point in the video: the pose/direction of the camera, the lens being used, its focal length, the white balance being used. The type of space 12 may also be stored, for example indicating whether it can readily represent a billboard, a van, a bus shelter or another substitute entity. Because this information is stored with the video, the post-production system that is to replace space 12 with alternative content can readily find places in the video where content can be replaced, readily select replacement content for such a space and readily replace the content in a way that allows it to appear as if it was present in the originally shot video. Meta data may be added, for example time of capture and location of capture.

The preview unit transmits the captured video stream to the storage unit 3, using connection 22. The information as transmitted includes:
1. The captured video stream or the captured stream as adapted by the preview unit. This is illustrated as data block 30.
2. Metadata indicating information about the timing, identity, position, size, shape and/or colouring of the space 12 as it appears in the in the transmitted video stream. The metadata may also indicate whether the transmitted video stream includes an element in the space 12 or not. This is illustrated as block 31. Timing information can indicate at which points in the video stream space 12 or another analogous space is visible. Identity information can indicate what type of object is intended to be depicted in a space. This can be derived from input terminal 26 or may be determined automatically. The metadata also includes information about the location of the shape relative to the camera or another reference location that is known with respect to the camera. This, with knowledge of the camera direction field of view, allows the position of the shape in the video stream to be estimated.

In order to form an overlay that represents a substitute object, the preview unit may store images of a range of objects in memory 25. It may then transform the shape and colour of a selected stored image and superimpose it on the captured video to form the adapted video stream.

The operator capturing the video or setting up scene 1 may be provided with guidelines indicating preferred positions for space 12. These guidelines may be selected so as to allow flexibility in the positioning of space 12, to make it easy to define spaces such as space 12 for a sufficient proportion of the length of the video stream that is being formed or to make the spaces suitable for adaptation to include desired content such as advertisements. The guidelines may provide recommendations as to one or more of the following aspects of how a substitutable space 12 may appear in a video:
the size of space 12 relative to the field of view of the video—for example it may be preferred for space 12 to occupy a contiguous region of between 20 and 40%, more preferably 25 to 30% of the field of view of the video;
the position of space 12 in the field of view of the video;
the colour of space 12—for example it may be preferred for it to be of a predetermined colour that can readily be identified for editing purposes such as green;
the aspect ratio of the space—for example if the space is to be replaced by a representation of a specific object (e.g. a bus shelter or a cereal box) it may be convenient for the space to have an aspect ratio substantially the same as that object.

The playout system 4 has access to advertisements stored in database 7 and also, if the video stream transmitted from preview unit 20 does not incorporate the overlays, images of suitable overlay objects. The overlay objects that are available and/or used may depend on the application of the system. For example:
When the system is being used to insert advertisements, it is convenient if the objects are ones that would conventionally bear advertisements. Then advertisements overlaid on those objects will not look out of place. Examples include billboards, bus shelters, the sides of vehicles, shop signage and branded products. Alternatively the overlay could be an overlay of an object that is being advertised: for example a specific model of car, watch or phone.
Where the system is being used to adapt the video stream for local customs and cultural expectations, it is convenient if the objects are ones that vary in appearance from location to location. Examples include buses, roadsigns, branded products and shop signage.
Where the system is being used to adapt the video stream to include text in a local language then the objects may conveniently be representations of text in appropriate languages.

Other uses of the system are possible.

When the playout system 4 is processing the video stream for playout to device 6 it performs the following steps:
1. If the metadata associated with the video stream to be played out does not include information indicating the timing and position of spaces that are to receive overlays then the playout system 4 analyses the video stream to identify suitable spaces. This may be done by means of a trained machine learning algorithm.
2. The playout system selects one or more spaces in the video stream that are to be overlain with advertising. These may be a subset of all the spaces in the video stream. In that case, if the video stream received by the playout system does not already incorporate overlays for the non-selected spaces then those spaces may be left unaltered, which will result in the original background from scene 1 appearing in their place; alternatively the overlays formed by the preview unit may be retained or overlain further by generic graphics as if an advertisement was being added in the way to be described below.
3. For each selected space the playout system selects a respective advertisement. The advertisements could be the same or different. The advertisement could be selected by summing for each available advertisement a set of weighted values and selecting the advertisement having the highest sum. One of those weighted values may relate to the advertisement's suitability to the user as estimated from the data received over channel 10. Another of the weighted values may relate to bids placed by advertisers to have their advertisements incorporated. The bids may depend on the context of the user device 6. Another of the weighted values may relate to the visual compatibility of the advertisement for the video stream surrounding a space where it could be inserted. In one embodiment, the algorithm could be configured to favour the selection of advertisements having similar colours to the surrounding regions. Analysis has indicated this to result in increased user engagement with advertisements inserted in video. In another embodiment, the algorithm could be configured to favour the selection of advertisements having colours that contrast with the surrounding regions.
4. Once an advertisement is selected, the playout system retrieves the appearance of that advertisement, for example as an image file. Then, for each frame in the video stream that includes the space in which the advertisement is be added, the playout system performs a transformation of the advertisement. Available transformations may include:
Cropping the advertisement to fit in that part of the space that is visible in the respective frame. This may be determined by the playout system visually analysing that frame, or by the playout system estimating the position and shape of the space in the frame by using the metadata. The position and shape of the space in the metadata may be estimated from a knowledge of the location of the space in the scene 1 and a knowledge of the field of view of the camera at the time the frame was captured. This may be obtained from the metadata.
Transforming the advertisement by stretching and/or rotation to correspond to the direction the camera was pointing when the frame was captured, parallax, lens distortion, perspective and so on. The required transformation can be determined by the playout system visually analysing that frame, or by the playout system estimating the position and shape of the space in the frame by using the metadata. For this purpose it may employ information about the direction the camera was pointing, the type of lens being used and its focal length when the frame was captured, and information about the distortion characteristics of that lens.
Altering the colouring of the advertisement to match that of the frame. For example, the white balance or hue may be adjusted in dependence on analysis of the image and/or the received metadata.
Changing the lighting of the advertisement to match ambient conditions in the video, or to spotlight it. Imposing a weathering or ageing effect, or a fog/cloud effect to match the environment depicted in the video.
Applying shadows to match those in the original video.
Applying a gap to the advertisement when an object in the video moves in front of the space 12.
Applying a distance blur in dependence on the distance the object is to be represented as being from the camera position.
Applying a focus blur depending on the focal point in the original video and optionally information from the metadata indicating the focal length and/or bokeh characteristics of the lens being used.
Applying one or more of a motion blur and an occlusion blur.
5. The playout unit overlays the transformed image on the respective frame and stores it and/or plays it out as a frame of an adapted video stream.

It will be appreciated that the steps above can be applied to overlay content other than advertisements.

At the editing stage, a computer (which may be a distributed computer) forming part of an editing suite may process a video stream to prepare it for the overlay of advertisements (e.g. by inserting objects in the video stream), or to insert overlay in the stream. Prior to doing so, the computer may process the video stream to assess whether the video stream is suitable for this processing. That may involve checking whether the video stream contains predetermined metadata or indicia that indicate it complies with one or more standardised formats making it readily possible to process the stream in that way.

One example workflow may proceed as follows, and is illustrated in FIG. 3.
1. A video stream 40 is captured, for example by a system described above, the stream comprising multiple segments or scenes (A-H). One or more of those scenes (E) contain spaces 12 which may be overlain with additional content.
2. There may be editing and production of the video stream to form a final programme.
3. A distribution video stream 41 is formed from the captured video 40 (optionally having been edited). The distribution video stream comprises all the scenes of the programme that is to be played out, in the order they are to be played out, except that one or more segments or scenes (“overlay scenes”) (E) are omitted. The overlay scenes (E₁-E₄) are stored separately and the overlay scenes are typically the original scene formed during the capture of the video stream 40, but which have been edited to include the desired overlays. Such editing can be in accordance with any of the methods described herein. The use of the original scene as the basis for the overlay scene ensures that the final broadcast video stream appears to be a single original video stream to the end user, rather than it being obvious that alternative material has been added or overlain onto the original scene. One or more markers 41 may be inserted in the distribution video stream 41 at the point where the overlay scenes have been removed. These may be the same as conventional markers for marking the location of an advertising break.
3. The distribution video stream 41 is provided to distributors who stream or broadcast video to consumers.
4. When a marker is reached, the distributor pauses playout of the distribution video stream in the usual way in order to allow advertisements to be played out to consumers.
5. At this point, instead of playing out conventional advertisements the playout system of an advertising provider plays out the overlay scene (E₁-E₄) that was omitted at the present point in the playout of the distribution scene, with the space(s) 12 in that overlay scene overlain with advertising material. Various versions (E₁-E₄) of the omitted scene (E) may be stored in a database 45, such that the overlaying has been carried out in advance and such that the most appropriate version of the omitted scene can then be supplied back into the distribution video stream 41. The advertising provider performs the overlaying in the manner described above. The overlay scene can be streamed or broadcast to consumers directly by the advertising provider or via the distributor, or the two could be the same entity. This may appear continuous with the end of the stream played out in step 3. In a preferred example, the distribution video stream 41 is combined with the overlay scene (E₁-E₄) prior to receipt by the end user on device 6. This combination maybe achieved by way of one or more processors 43 that may be located virtually, i.e. in the cloud 5, or may exist physically. Importantly, the end user device 6 requires no additional software or hardware to view the combined video as only a single broadcast 44 is received by the device 6. In this way, the user's enjoyment can be improved, as any timing issues concerning the combination of the different video streams are addressed before the broadcast is received by the end user device 6.
6. When the overlay scene is complete, the distributor resumes playout of the distribution video stream. This may appear continuous with the end of the stream played out in step 5.

This approach allows a video stream to be played out using current streaming schemas (with a played-out video being paused for the insertion of advertisements at appropriate times) but with the content that is provided in advertising breaks being integral with the principal content. This can increase the engagement and enjoyment of viewers. Unlike existing systems and methods that stream personalised video to a user, whereby the advertisements or other personalised content is in addition to the original intended video, the present idea allows the personalisation to be part of the intended video, rather than an addition thereto. As a result, the duration of the gap between the stopping and restarting of the second video stream is always constant, no mater what personalisation has been added, due to the use of the originally created scene(s) being the base for the overlain video stream. Thus the personalised video stream is always the same duration irrespective of the advertisement added. Furthermore, as the overlain scene E has come from the original video stream 40, such that the durations of the omission and the overlain video stream (E₁-E₄) are the same, there is no need for any handshake at the end of overlain video stream (E₁-E₄).

Furthermore, by using original scene(s), the transition between the distribution video stream 41 and the overlain video stream (E₁-E₄), i.e. between D and E in FIG. 3, and then from the overlain video stream (E₁-E₄) to the continuation of the distribution video stream 41, i.e. between E and F in FIG. 3, can be seamless. By this, we mean that the transition occurs immediately at the frame banding between D and E, and then at the frame banding between E and F, such that to the user, it is as if D and E or E and F had been filmed together. Sound between adjacent streams is also preferably arranged such the user hears no interface between the different streams. This may be achieved by using handles to fade the sound in and out between adjacent streams.

The selection of the appropriate content to apply as an overlay is described above. In any of those methods, some identification information is required to determine what content should be applied for a given end user. This information may come from the user directly, for example as a signal from the end device 6, or may come from data held by the distributor of one or more of the video streams, or may come from an Internet Service Provider or other company hosting the cloud 5 or physical devices into which the video streams are provided and/or combined prior to onward transmission to the end user.

When a video stream is to be processed to bear an overlay, one option is for the original video stream to include a space depicting an object (e.g. a bus shelter), and for the overlay to be placed over that object as it appears in the video stream. A second option is for the original video stream not to depict such an object but to incorporate a visible space dedicated for insertion of an object of that type or of a predetermined set of types. For example, a flat area of ground may be left unoccupied by actors so that a bus shelter, a van or an advertising hoarding may be inserted there and overlain, e.g. by advertisements. A third option is to analyse the original video stream to identify spaces suitable for the insertion of objects. This may be done manually or automatically by a computer implementing image analysis software. The object(s) to be inserted may be selected manually or automatically by a computer implementing image analysis software. The object(s) to be inserted may be selected automatically in dependence on the environment depicted in the video stream. For example if the video stream depicts a highway then objects such as a bus shelter or a van, which might normally be expected to be seen in such an environment may be selected for insertion. This selection can be done by suitably trained machine learning software. When an object has been selected, an image or model of such an object can be retrieved from a database or library of objects, e.g. as a three-dimensional mode. Then the object may be inserted as depicted in that model.

In examples given above, the original video stream is captured by a camera. The original video stream may be a computer-generated stream, or may be a combination of a real stream captured by a camera and a computer-generated stream (formed e.g. by rotoscoping). The video stream may be a conventional (2D) video stream or a 3D and/or virtual reality video stream.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A method for playing out a video stream, the method comprising:
forming a first video stream for playout, the first video stream depicting at least one space for substitution by an overlay;
forming a second video stream for playout, the second video stream having an omission corresponding to the first video stream;
playing out the second video stream;
stopping playout of the second video stream at the omission;
subsequently, playing out the first video stream with the space substituted by an overlay;
subsequently playing out a further portion of the second video stream.

2. A method according to claim 1, wherein the first video stream is formed by extracting a portion from the second video stream without the omission.

3. A method according to claim 1, further comprising substituting different overlays onto alternative copies of the first video stream to form a database of overlain first video streams.

4. A method according to claim 3, wherein each overlain video stream is identical in duration.

5. A method according to claim 1, wherein the first and second video streams are combined into a single broadcast video stream prior to sending to a viewer.

6. A method according to claim 1, wherein a transition between first and second video streams is without additional video material therebetween.

7. A method for capturing a video stream, the method comprising storing video captured by a camera together with metadata indicating a location in the video at which a predesignated substitution object appears.

8. A system for capturing a video stream, the system comprising:
a camera; and
an encoding device configured to store video captured by the camera together with metadata indicating a location in the video at which a predesignated substitution object appears.

9. A system as claimed in claim 8, wherein the metadata indicates times during the video at which the substitution object appears.

10. A system as claimed in claim 8, wherein the metadata indicates regions of the video occupied by the substitution object over time.

11. A system as claimed in claim 8, wherein the metadata indicates a size and shape of the substitution object.

12. A system as claimed in claim 8, wherein the metadata indicates one or more characteristics of a lens of the camera at one or more times when the substitution object appears in the video.

13. A system as claimed in claim 8, wherein the metadata indicates one or more colour characteristics of the video at one or more times when the substitution object appears in the video.

14. A system as claimed in claim 8, wherein the system comprises an input device whereby a user can input at least some of the metadata to the system.

15. A system for processing video to replace substitutable content in the video with alternative content, the system comprising a processor configured to:
process metadata associated with the video to identify a region in the video in which the substitutable content appears;
select, in dependence on the metadata, an item of alternative content from a datastore storing alternative content; and
process the video to replace regions of the video defined by the metadata with substituted content formed in dependence on the alternative content.

16. A system as claimed in claim 15, wherein the metadata indicates a pose of a camera that captured the video at a time when the substitutable content appears in the video, and the processor is configured to spatially distort the alternative content in dependence on the indicated pose to form the substituted content.

17. A system as claimed in claim 15, wherein the metadata indicates one or more characteristics of a lens of the camera at a time when the substitutable content object appears in the video, and the processor is configured to spatially distort the alternative content in dependence on the indicated lens characteristics to form the substituted content.

18. A system as claimed in claim 15, wherein the metadata indicates one or more colour characteristics of the video at a time when the substitutable content appears in the video, and the processor is configured to chromatically distort the alternative content in dependence on the indicated lens characteristics to form the substituted content.

19. A method for processing a video stream to replace substitutable content in the video stream with alternative content, the method comprising:
processing metadata associated with the video stream to identify a region in the video stream in which the substitutable content appears;
selecting, in dependence on the metadata, an item of alternative content from a datastore storing alternative content; and
processing the video stream to replace regions of the video stream defined by the metadata with substituted content formed in dependence on the alternative content.

20. A method as claimed in claim 19, comprising processing the video stream to determine whether the video stream contains data indicating that it complies with one or more standard formats, and replacing regions of the video stream as claimed in claim 14 only if the video stream contains such data.

21. A method for processing a video stream to replace substitutable content in the video stream with alternative content, the method comprising:
processing the video stream using a computer programmed to implement an image recognition algorithm to identify in the video stream depictions of an environment having a propensity to contain one or more predetermined objects;
retrieving from a data store a model of one of the predetermined objects; and
processing the video stream to replace regions of the video stream depicting the identified environment with substituted content formed in dependence on the retrieved model.
